(19) United States
(12) Patent Application Publication
(10) Pub. No.: US 2025/0136101 A1
(43) Pub. Date: May 1, 2025

(54) TRANSFER STATION

(71) Applicant: Oshkosh Corporation, Oshkosh, WI (US)

(72) Inventors: Vince Schad, Oshkosh, WI (US); Andy Cornelius, Oshkosh, WI (US); Nick Weykamp, Oshkosh, WI (US); Quincy Wittman, Oshkosh, WI (US); Jerrod Kappers, Oshkosh, WI (US); Brendan Chan, Oshkosh, WI (US); Eric Olson, Oshkosh, WI (US); Zhenyi Wei, Oshkosh, WI (US); Alec Ehlke, Oshkosh, WI (US); Jeff Meyer, Oshkosh, WI (US); Umang Patel, Oshkosh, WI (US); Austin Mahoney, Oshkosh, WI (US); Thomas Vale, Oshkosh, WI (US); William Young, Oshkosh, WI (US); Johnny Bui, Oshkosh, WI (US); Nagabhushana Sharma Gurumurthy, Oshkosh, WI (US)

(73) Assignee: Oshkosh Corporation, Oshkosh, WI (US)

(21) Appl. No.: 18/925,839

(22) Filed: Oct. 24, 2024

Related U.S. Application Data
(60) Provisional application No. 63/593,772, filed on Oct. 27, 2023.

(51) Int. Cl. B60W 30/09; B60W 30/095; B60W 60/00; G01C 21/34

(52) U.S. Cl. CPC B60W 30/09; B60W 30/0953; B60W 30/0956; B60W 60/0015; G01C 21/3461; B60W 2530/10; B60W 2554/40; B60W 2554/80

(57) ABSTRACT

A system for directing vehicles in a refuse transfer station comprising: an electronic device; a communication hub; and one or more processors configured to: receive an indication from the electronic device of a first location of at least one object and a second location of at least one vehicle; map the location of the first location and the second location; determine a path between the first location and the second location; and transmit, through the communication hub, to the at least one vehicle the path between the first location and the second location.

### CROSS-REFERENCE TO RELATED PATENT APPLICATIONS

This application claims the benefit of and the priority to U.S. Provisional Patent Application No. 63/593,772, filed Oct. 27, 2023, the entire disclosure of which is incorporated by reference herein.

### BACKGROUND

The present disclosure generally relates to the field of refuse vehicles. More specifically, the present disclosure relates to control systems for refuse vehicles.

### SUMMARY

In some aspects, the techniques described herein relate to a system including: a vehicle measuring device; a transfer zone; and a vehicle transport device, the vehicle transport device including: a vehicle-coupling mechanism to couple to at least one vehicle; a vehicle-directing mechanism to direct the at least one vehicle coupled to the vehicle-coupling mechanism along a predefined path including the vehicle measuring device and the transfer zone; one or more processors; and a non-transitory computer-readable medium containing instructions that when executed by the one or more processors cause the one or more processors to: receive an indication of the at least one vehicle being coupled to the vehicle-coupling mechanism; and responsive to receiving the indication of the at least one vehicle being coupled to the vehicle-coupling mechanism, adjusting one or more operating parameters of the vehicle-directing mechanism to direct the at least one vehicle along the predefined path.

In some aspects, the techniques described herein relate to a system, wherein the predefined path leads the at least one vehicle between at least two of the vehicle measuring device, the transfer zone, and a queue.

In some aspects, the techniques described herein relate to a system, wherein the vehicle-directing mechanism is a conveyor on which at least a portion of the at least one vehicle is supported.

In some aspects, the techniques described herein relate to a system, wherein the vehicle-directing mechanism is a tug vehicle configured to couple to a hitch or a tractive element of the at least one vehicle.

In some aspects, the techniques described herein relate to a system, wherein the vehicle-directing mechanism is a refuse vehicle and the vehicle-coupling mechanism is a hitch and tow bar.

In some aspects, the techniques described herein relate to a refuse vehicle including: a chassis; one or more tractive elements; a prime mover; one or more processors configured; and a non-transitory computer-readable medium containing instructions that when executed by the one or more processors cause the one or more processors to: receive an indication of a presence of a mobile object; determine a distance between the refuse vehicle and the mobile object; responsive to the distance between the refuse vehicle and the mobile object exceeding a first threshold, adjusting at least one operating parameter of the refuse vehicle to advance the refuse vehicle toward the mobile object; and responsive to the distance between the refuse vehicle and the mobile object not exceeding the first threshold, adjusting the at least one operating parameter of the refuse vehicle to stop the refuse vehicle from advancing towards the mobile object.

In some aspects, the techniques described herein relate to a refuse vehicle, wherein the instructions further cause the one or more processors to adjust the at least one operating parameter along a predefined path toward a transfer zone.

In some aspects, the techniques described herein relate to a refuse vehicle, wherein the instructions further cause the one or more processors to: maintain the refuse vehicle in a positional location outside the transfer zone in response to arriving at the transfer zone; and in response to receiving an indication of a vacancy within the transfer zone, adjusting the at least one operating parameter of the refuse vehicle to enter the transfer zone.

In some aspects, the techniques described herein relate to a refuse vehicle, wherein the instructions further cause the one or more processors to: cause the refuse vehicle to enter the transfer zone; and adjust the at least one operating parameter such that the refuse vehicle approaches a dump site within the transfer zone in a reverse direction.

In some aspects, the techniques described herein relate to a refuse vehicle, wherein the mobile object is a second refuse vehicle.

In some aspects, the techniques described herein relate to a refuse vehicle, wherein the instructions further cause the one or more processors to adjust the at least one operating parameter in response to the refuse vehicle being within a geofenced location associated with a refuse transfer station.

In some aspects, the techniques described herein relate to a refuse vehicle, wherein the instructions further cause the one or more processors to receive a communication associated with a position of the mobile object.

In some aspects, the techniques described herein relate to a refuse vehicle, wherein the one or more processors are configured to receive the communication from the mobile object.

In some aspects, the techniques described herein relate to a system for reducing wait times at a refuse transfer station including: a measuring device; one or more processors communicably coupled to the measuring device; and a non-transitory computer-readable medium containing instructions that when executed by the one or more processors cause the one or more processors to: receive, from the measuring device, a measured weight of a payload of a refuse vehicle, determine, based on the measured weight, a wait time for the refuse vehicle to discharge the payload at the refuse transfer station, and transmit the wait time to the refuse vehicle.

In some aspects, the techniques described herein relate to a system, wherein the instructions further cause the one or more processors to determine, based on the measured weight, a billing charge for the payload.

In some aspects, the techniques described herein relate to a system, wherein the instructions further cause the one or more processors to authenticate the measured weight as a certified measured weight.

In some aspects, the techniques described herein relate to a system, wherein the instructions further cause the one or more processors to: receive an indication of an arrival of the refuse vehicle at the refuse transfer station; responsive to authenticating the measured weight as the certified measured weight and receiving the indication of the arrival of the refuse vehicle at the refuse transfer station: update a billing ledger associated with the refuse vehicle with the billing charge; and transmit for display a communication indicating that the refuse vehicle may discharge the payload.

In some aspects, the techniques described herein relate to a system, wherein the one or more processors receive the measured weight of the payload of the refuse vehicle by comparing a preload weight captured by the measuring device to a post-load weight captured by the measuring device.

In some aspects, the techniques described herein relate to a system, wherein the measuring device is positioned onboard the refuse vehicle.

In some aspects, the techniques described herein relate to a system, wherein the measuring device is a scale external to the refuse vehicle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4 is a block diagram of a control system for any of the refuse vehicles of FIGS. 1-3, according to an exemplary embodiment;

FIG. 5 is a diagram illustrating a collection route for autonomous transport and collection by any of the refuse vehicles of FIGS. 1-3, according to an exemplary embodiment;

FIG. 6 is diagram of a refuse transfer station employing an automated vehicle queue, according to an exemplary embodiment;

FIG. 7 is a side view of an automated queueing system, according to an exemplary embodiment;

FIG. 8 is side view of a first refuse vehicle towing a second refuse vehicle, according to an exemplary embodiment;

FIG. 9 is a side view of an automated track queuing system, according to an exemplary embodiment;

FIG. 10 is a top view of an automated track queuing system, according to an exemplary embodiment; and

FIG. 11 is a flow diagram of a process for automating a transfer station queue, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Referring generally to the FIGURES, systems for automating coordinated movements of one or more vehicles (e.g., refuse vehicles) in a transfer station (e.g., a refuse transfer station) are shown. The systems may use a variety of sensors and/or vehicle control systems to coordinate the operation of one or more refuse vehicles to discharge a loaded payload at a refuse transfer station. The systems may be executed locally on an individual vehicle, or by a server remote to the vehicle. The systems may provide mapping and planning details to the vehicle based on received and/or stored data associated with known objects within the refuse transfer station. The systems may automatically update the planning and mapping details/data based on received data from one or more sensors.

In some embodiments, the systems may include and/or communicate with hardware devices to manage a queue of vehicles at the transfer station through an automated motion of the hardware devices.

### Refuse Vehicle

### Front-Loading Configuration

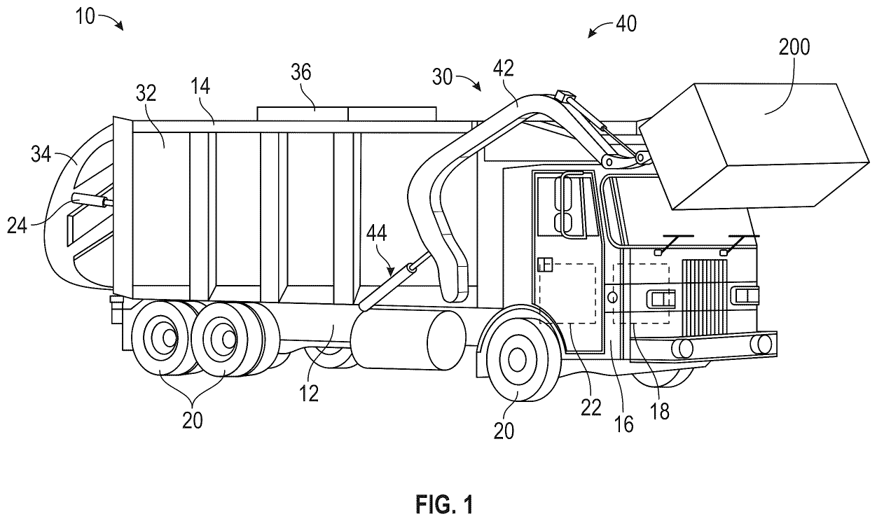

Referring to FIG. 1, a vehicle, shown as refuse vehicle 10 (e.g., a garbage truck, a waste collection truck, a sanitation truck, etc.), is shown that is configured to collect and store refuse along a collection route. In the embodiment of FIG. 1, the refuse vehicle 10 is configured as a front-loading refuse vehicle. The refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled to the frame 12 at a position beneath the cab 16. The engine 18 is configured to provide power to tractive elements, shown as wheels 20, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the tractive elements 20 (e.g., wheels, wheel assemblies, etc.) of the refuse vehicle 10 through a transmission 22. The engine 18, the transmission 22, and one or more shafts, axles, gearboxes, etc., may define a driveline of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, transfer station, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned forward of the cab 16 (e.g., refuse is loaded into a position of the refuse compartment 30 in front of the cab 16, a front-loading refuse vehicle, etc.). In other embodiments, the hopper volume is positioned between the storage volume and the cab 16 (e.g., refuse is loaded into a position of the refuse compartment 30 behind the cab 16 and stored in a position further toward the rear of the refuse compartment 30). In yet other embodiments, the storage volume is positioned between the hopper volume and the cab 16 (e.g., a rear-loading refuse vehicle, etc.).

The tailgate 34 may be hingedly or pivotally coupled with the body 14 at a rear end of the body 14 (e.g., opposite the cab 16). The tailgate 34 may be driven to rotate between an open position and a closed position by tailgate actuators 24. The refuse compartment 30 may be hingedly or pivotally coupled with the frame 12 such that the refuse compartment 30 can be driven to raise or lower while the tailgate 34 is open in order to dump contents of the refuse compartment 30 at a landfill. The refuse compartment 30 may include a packer assembly (e.g., a compaction apparatus) positioned therein that is configured to compact loose refuse.

Referring still to FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled to at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled to frame 12 with a pivot (e.g., a lug, a shaft, etc.). The lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the pivot, according to an exemplary embodiment. Lift arms 42 may be removably coupled to a container, shown as refuse container 200 in FIG. 1. Lift arms 42 are configured to be driven to pivot by lift arm actuators 44 to lift and empty the refuse container 200 into the hopper volume for compaction and storage. The lift arms 42 may be coupled with a pair of forks or elongated members that are configured to removably couple with the refuse container 200 so that the refuse container 200 can be lifted and emptied. The refuse container 200 may be similar to the container attachment 200 as described in greater detail in U.S. application Ser. No. 17/558,183, filed Dec. 12, 2021, the entire disclosure of which is incorporated by reference herein.

### Rear-Loading Configuration

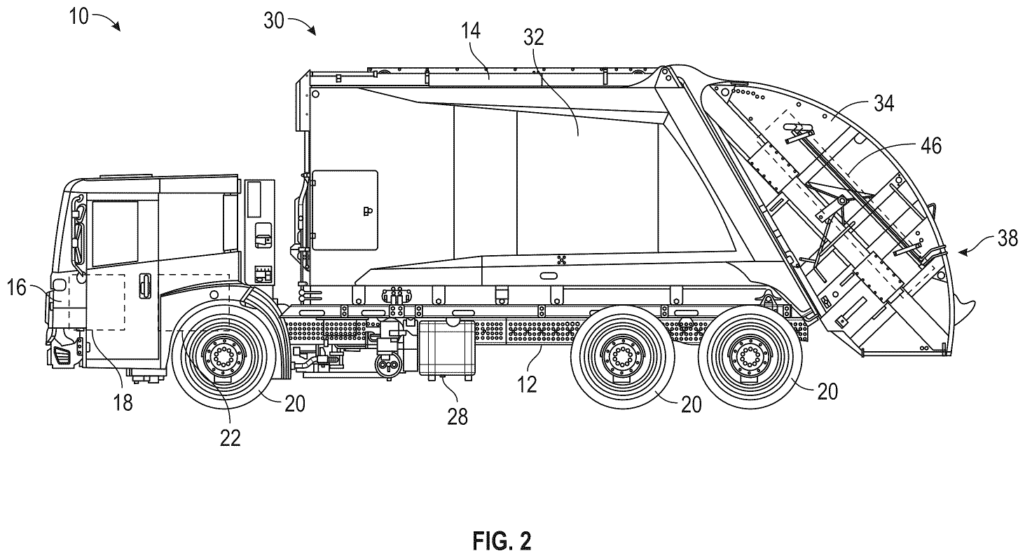

As shown in FIG. 2, the refuse vehicle 10 may be configured as a rear-loading refuse vehicle, according to some embodiments. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation.

### Side-Loading Configuration

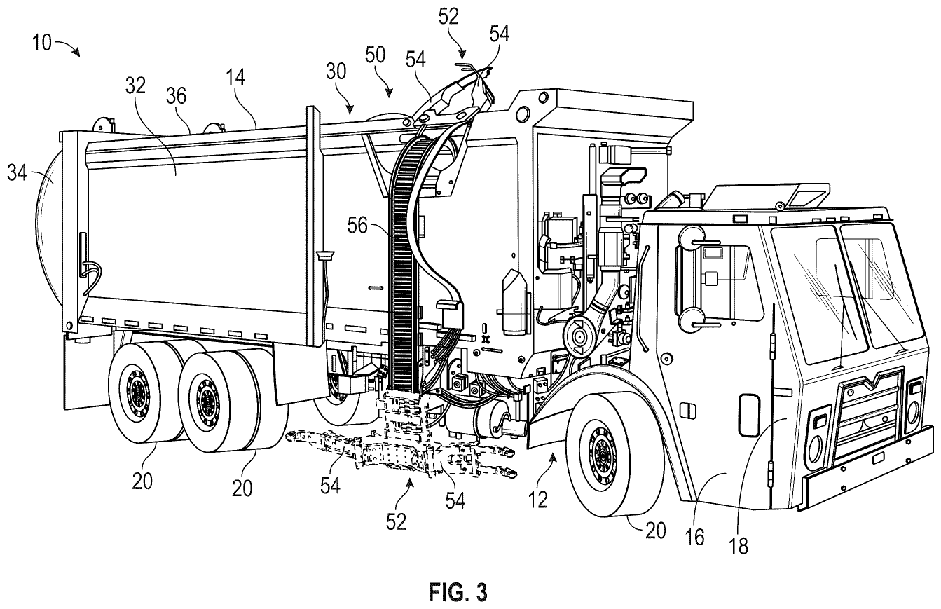

Referring to FIG. 3, the refuse vehicle 10 may be configured as a side-loading refuse vehicle (e.g., a zero radius side-loading refuse vehicle). The refuse vehicle 10 includes first lift mechanism or system, shown as lift assembly 50. Lift assembly 50 includes a grabber assembly, shown as grabber assembly 52, movably coupled to a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 3, grabber assembly 52 includes a pair of grabber arms shown as grabber arms 54. The grabber arms 54 are configured to rotate about an axis extending through a bushing. The grabber arms 54 are configured to releasably secure a refuse container to grabber assembly 52, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56, and return the refuse container to the ground. Once the refuse container has been placed on the ground, the grabber assembly may transition into the disengaged state, releasing the refuse container.

### Control System

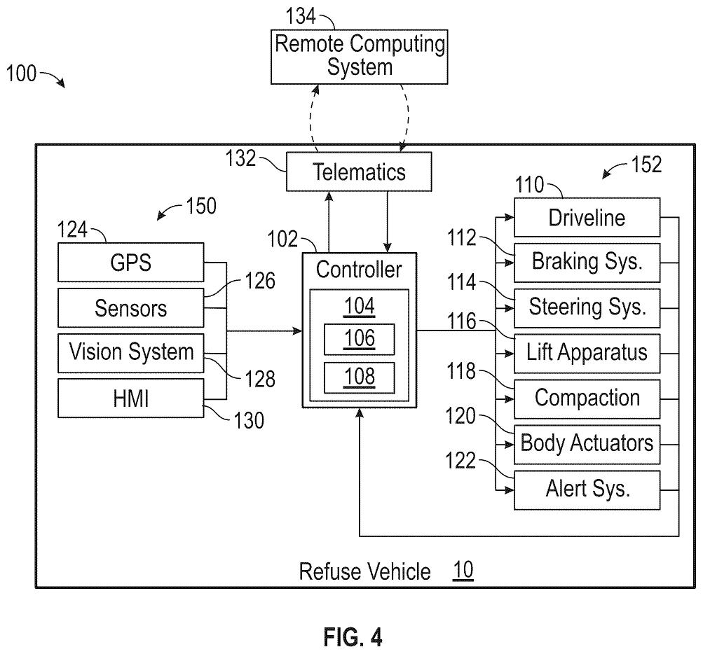

Referring to FIG. 4, the refuse vehicle 10 may include a system 100 that is configured to facilitate autonomous or semi-autonomous operation of the refuse vehicle 10, or components thereof. The system 100 includes a controller 102 that is positioned on the refuse vehicle 10, a remote computing system 134, a telematics unit 132, one or more input devices 150, and one or more controllable elements 152. The input devices 150 can include a Global Positioning System (“GPS”), multiple sensors 126, a vision system 128 (e.g., an awareness system), and a Human Machine Interface (“HMI”). The controllable elements 152 can include a driveline 110 of the refuse vehicle 10, a braking system 112 of the refuse vehicle 10, a steering system 114 of the refuse vehicle 10, a lift apparatus 116 (e.g., the lift assembly 40, the lift assembly 50, etc.), a compaction system 118 (e.g., a packer assembly, the packer 46, etc.), body actuators 120 (e.g., tailgate actuators 24, lift or dumping actuators, etc.), and/or an alert system 122.

The controller 102 includes processing circuitry 104 including a processor 106 and memory 108. Processing circuitry 104 can be communicably connected with a communications interface of controller 102 such that processing circuitry 104 and the various components thereof can send and receive data via the communications interface. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to some embodiments, memory 108 is communicably connected to processor 106 via processing circuitry 104 and includes computer code for executing (e.g., by at least one of processing circuitry 104 or processor 106) one or more processes described herein.

The controller 102 is configured to receive inputs (e.g., measurements, detections, signals, sensor data, etc.) from the input devices 150, according to some embodiments. In particular, the controller 102 may receive a GPS location from the GPS system 124 (e.g., current latitude and longitude of the refuse vehicle 10). The controller 102 may receive sensor data (e.g., engine temperature, fuel levels, transmission control unit feedback, engine control unit feedback, speed of the refuse vehicle 10, etc.) from the sensors 126. The controller 102 may receive image data (e.g., real-time camera data) from the vision system 128 of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 16 of the refuse vehicle 10, etc.). The controller 102 may receive user inputs from the HMI 130 (e.g., button presses, requests to perform a lifting or loading operation, driving operations, steering operations, braking operations, etc.).

The controller 102 may be configured to provide control outputs (e.g., control decisions, control signals, etc.) to the driveline 110 (e.g., the engine 18, the transmission 22, the engine control unit, the transmission control unit, etc.) to operate the driveline 110 to transport the refuse vehicle 10. The controller 102 may also be configured to provide control outputs to the braking system 112 to activate and operate the braking system 112 to decelerate the refuse vehicle 10 (e.g., by activating a friction brake system, a regenerative braking system, etc.). The controller 102 may be configured to provide control outputs to the steering system 114 to operate the steering system 114 to rotate or turn at least two of the tractive elements 20 to steer the refuse vehicle 10. The controller 102 may also be configured to operate actuators or motors of the lift apparatus 116 (e.g., lift arm actuators 44) to perform a lifting operation (e.g., to grasp, lift, empty, and return a refuse container). The controller 102 may also be configured to operate the compaction system 118 to compact or pack refuse that is within the refuse compartment 30. The controller 102 may also be configured to operate the body actuators 120 to implement a dumping operation of refuse from the refuse compartment 30 (e.g., driving the refuse compartment 30 to rotate to dump refuse at a landfill). The controller 102 may also be configured to operate the alert system 122 (e.g., lights, speakers, display screens, etc.) to provide one or more aural or visual alerts to nearby individuals.

The controller 102 may also be configured to receive feedback from any of the driveline 110, the braking system 112, the steering system 114, the lift apparatus 116, the compaction system 118, the body actuators 120, or the alert system 122. The controller may provide any of the feedback to the remote computing system 134 via the telematics unit 132. The telematics unit 132 may include any wireless transceiver, cellular dongle, communications radios, antennas, etc., to establish wireless communication with the remote computing system 134. The telematics unit 132 may facilitate communications with telematics units 132 of nearby refuse vehicles 10 to thereby establish a mesh network of refuse vehicles 10.

The controller 102 is configured to use any of the inputs from any of the GPS 124, the sensors 126, the vision system 128, or the HMI 130 to generate controls for the driveline 110, the braking system 112, the steering system 114, the lift apparatus 116, the compaction system 118, the body actuators 120, or the alert system 122. In some embodiments, the controller 102 is configured to operate the driveline 110, the braking system 112, the steering system 114, the lift apparatus 116, the compaction system 118, the body actuators 120, and/or the alert system 122 to autonomously transport the refuse vehicle 10 along a route (e.g., self-driving), perform pickups or refuse collection operations autonomously, and transport to a landfill to empty contents of the refuse compartment 30. The controller 102 may receive one or more inputs from the remote computing system 134 such as route data, indications of pickup locations along the route, route updates, customer information, pickup types, etc. The controller 102 may use the inputs from the remote computing system 134 to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

In some embodiments, the remote computing system 134 is configured to interact with (e.g., control, monitor, etc.) the refuse vehicle 10 through a virtual refuse truck as described in U.S. application Ser. No. 16/789,962, now U.S. Pat. No. 11,380,145, filed Feb. 13, 2020, the entire disclosure of which is incorporated by reference herein. The remote computing system 134 may perform any of the route planning techniques as described in greater detail in U.S. application Ser. No. 18/111,137, filed Feb. 17, 2023, the entire disclosure of which is incorporated by reference herein. The remote computing system 134 may implement any route planning techniques based on data received by the controller 102. In some embodiments, the controller 102 is configured to implement any of the cart alignment techniques as described in U.S. application Ser. No. 18/242,224, filed Sep. 5, 2023, the entire disclosure of which is incorporated by reference herein. The refuse vehicle 10 and the remote computing system 134 may also operate or implement geofences as described in greater detail in U.S. application Ser. No. 17/232,855, filed Apr. 16, 2021, the entire disclosure of which is incorporated by reference herein.

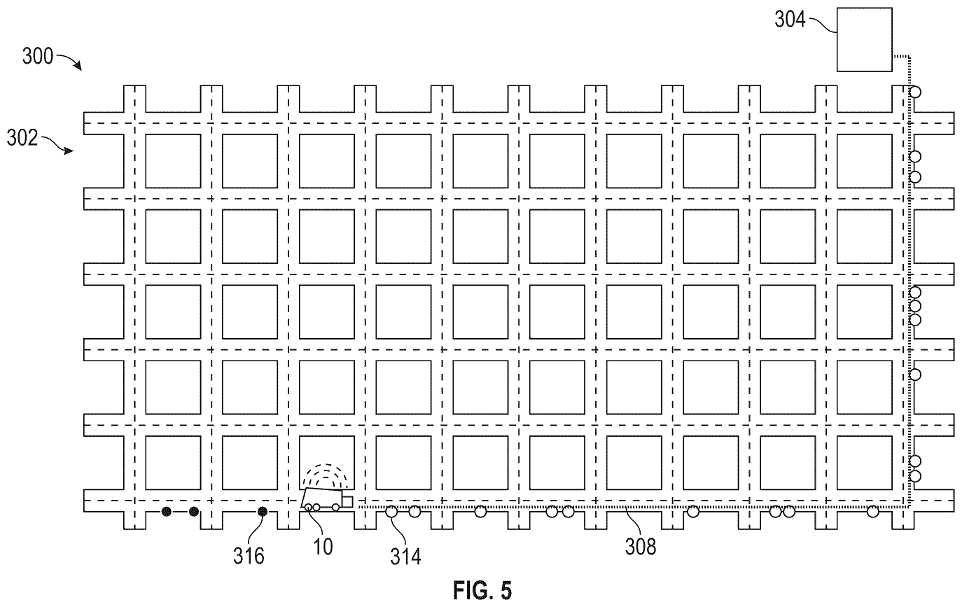

Referring to FIG. 5, a diagram 300 illustrates a route 308 through a neighborhood 302 for the refuse vehicle 10. The route 308 includes future stops 314 along the route 308 to be completed, and past stops 316 that have already been completed. The route 308 may be defined and provided by the remote computing system 134. The remote computing system 134 may also define or determine the future stops 314 and the past stops 316 along the route 308 and provide data regarding the geographic location of the future stops 314 and the past stops 316 to the controller 102 of the refuse vehicle 10. The refuse vehicle 10 may use the route data and the stops data to autonomously transport along the route 308 and perform refuse collection at each stop. The route 308 may end at a landfill 304 (e.g., an end location) where the refuse vehicle 10 may autonomously empty collected refuse, transport to a refueling location if necessary, and begin a new route.

### Transfer Station Coordination

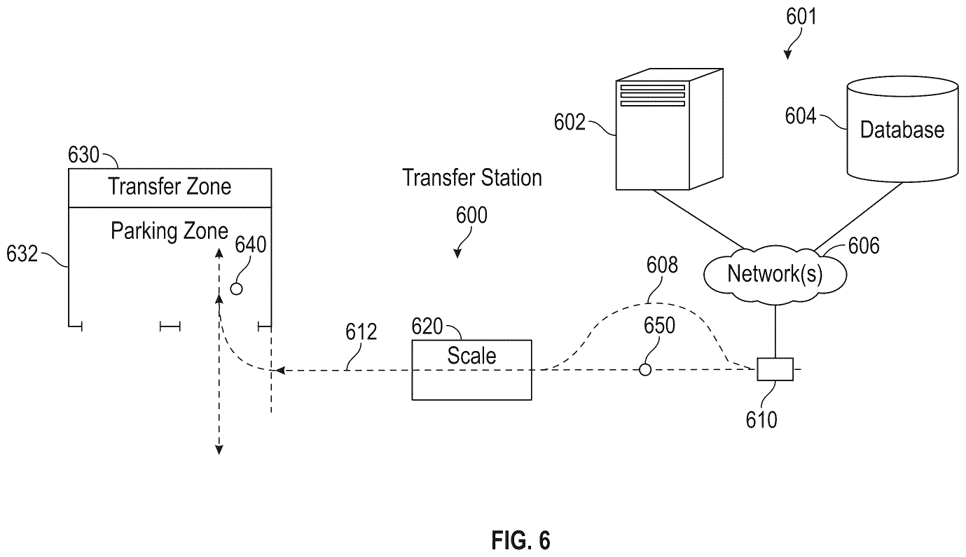

Referring to FIG. 6, a system 601 for mapping/planning routes (e.g., route 612) for a vehicle 610 (e.g., a refuse vehicle) in a transfer station 600 (e.g., the landfill 304 of FIG. 5, a refuse transport location, etc.). FIG. 6 illustrates various components of the system 601 for automating queue movements of the vehicle 610, according to an embodiment. The system 601 may include a server 602, a database 604, and/or a vehicle 610. In some embodiments, in addition to or in place of the vehicle 810, the system 601 includes an electronic device communicably coupled to the vehicle 610. The various devices and components of the system 601 may communicate with one another via one or more networks 606. In some embodiments, the system 601 may include a communication hub communicatively coupled to one or more vehicles 610 and the various other components of the system 601 for facilitating communications between the various components of the system 601 and the one or more vehicles 610.

For ease of description and understanding, FIG. 6 depicts the system 601 as having only one or a small number of each component. Embodiments may, however, comprise additional or alternative components, or omit certain components, from those of FIG. 6 and still fall within the scope of this disclosure. As an example, it may be common for embodiments to include multiple servers 602 and/or multiple databases 604 that are communicably coupled to the server 602 and the vehicle 610 through the network 606. Embodiments may include or otherwise implement any number of devices capable of performing the various features and tasks described herein. For instance, FIG. 1 depicts the database 604 as hosted as a distinct computing device from the server 602, though, in some embodiments, the server 602 may include an integrated database 604 hosted by the server 602.

The system 601 includes one or more networks 606, which may include any number of internal networks, external networks, private networks (e.g., intranets, VPNs), and public networks (e.g., Internet). The networks 606 comprise various hardware and software components for hosting and conduct communications amongst the components of the system 601. Non-limiting examples of such internal or external networks 606 may include a Local Area Network (LAN), Wireless Local Area Network (WLAN), Metropolitan Area Network (MAN), Wide Area Network (WAN), and the Internet. The communication over the networks 606 may be performed in accordance with various communication protocols, such as Transmission Control Protocol and Internet Protocol (TCP/IP), User Datagram Protocol (UDP), and IEEE communication protocols, among others.

The vehicle 610 may include an electronic device comprising hardware components (e.g., one or more processors, non-transitory storage) and software components capable of performing the various processes and tasks described herein. Non-limiting examples of the electronic device within vehicle 610 include personal computers (e.g., laptop computers, desktop computers), server computers, mobile devices (e.g., smartphones, tablets), VR devices, and gaming consoles, smart watches, vehicle control boards, among other types of electronic devices. In some embodiments, the electronic device in the vehicle 610 may be the controller 102 of FIG. 4.

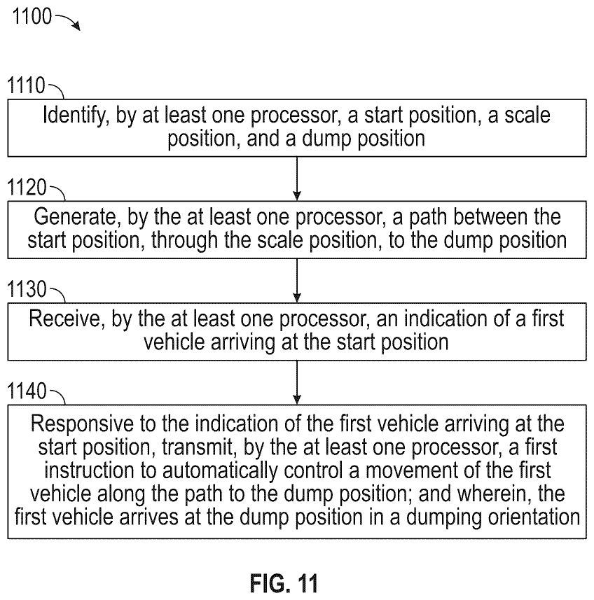

The server 602 may execute one or more software programs to perform various methods and processes (e.g., the process 1100 of FIG. 11). The server 602 may include one or more computing devices configured to perform various processes and operations disclosed herein. In some embodiments, the server 602 may be a computer or computing device capable of performing methods disclosed herein. The server 602 may include a processor and non-transitory, computer readable medium including instructions, which, when executed by the processor, caused the processor to perform methods disclosed herein. The processor may include any number of physical, hardware processor. Although FIG. 6 shows only a single server 602, the server 602 may include any number of computing devices. In some cases, the computing devices of the server 602 may perform all or portions of the processes and benefits of the server 602. The server 602 may comprise computing devices operating in a distributed or cloud computing configuration and/or in a virtual machine configuration. It should also be appreciated that, in some embodiments, functions of the server 602 may be partly or entirely performed by the vehicle 610.

For example, the vehicle 610 may execute one or more software programs to perform various methods and processes (e.g., the process 1100 of FIG. 11). The vehicle 610 may include one or more computing devices configured to perform various processes and operations disclosed herein. In some embodiments, the vehicle 610 may be a computer or computing device capable of performing methods disclosed herein. In some embodiments, the vehicle 610 may be a mobile computing device (e.g., cellular device). The vehicle 610 may include a processor and non-transitory, computer-readable medium including instructions, which, when executed by the processor, caused the processor to perform methods disclosed herein. The processor may include any number of physical, hardware processors. Although FIG. 6 shows only a single vehicle 610, the vehicle 610 any include any number of computing devices. In some cases, the computing devices of the vehicle 610 may perform all or portions of the processes and benefits of the vehicle 610. The vehicle 610 may comprise computing devices operating in a distributed or cloud computing configuration and/or in a virtual machine configuration.

The transfer station 600 is a location in which vehicles transfer a payload. For example, the vehicle 610 may be a refuse vehicle with refuse as payload. The vehicle 610 may transport the payload to the transfer station 600 to dump the refuse in a transfer zone 630 (e.g., a dump zone). The transfer zone 630 may be part of a landfill, another vehicle, or a location from which the refuse will be loaded into another vehicle. The transfer station 600 includes a scale 620 with which the vehicle 610 is weighed before and after dumping the payload at the transfer zone 630. By weighing the vehicle 610 before and after the dumping, the weight of the refuse dumped in the transfer zone 630 may be measured. This measured weight is used to determine a bill amount to charge the vehicle 610. A parking zone 632 is the area in which the vehicle 610 parks to unload the payload into the transfer zone 630. The parking zone 632 can be a dangerous area as vehicles are constantly backing up with limited visibility and dumping refuse. In addition, transfer station 600 personnel are often present in the parking zone 632 to direct vehicles to where to park These personnel are often at risk of being hit by the vehicle 610 or by the payload being dumped by the vehicle 610.

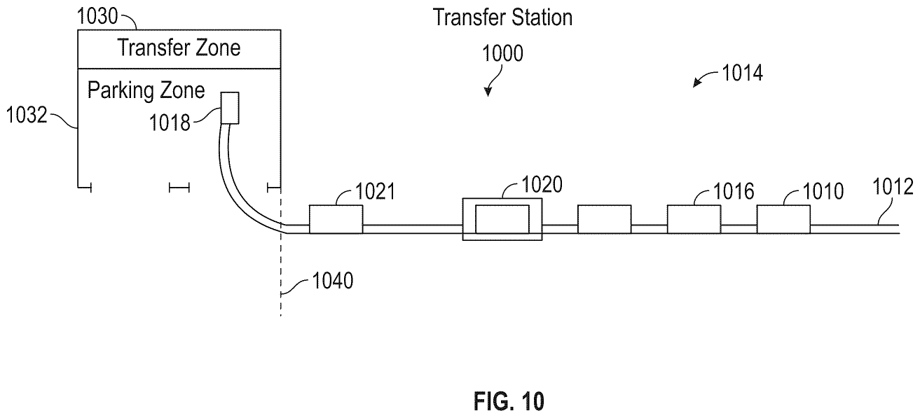

In addition to the dangers of the transfer station 600, time is often wasted waiting in a dump queue (e.g., dump queue 1014 of FIG. 10). In some embodiments, the system 601 notifies the operator of the vehicle 610 that a queue has formed at the transfer station 600. This allows the operator of the vehicle 610 to reroute to an alternative transfer station to avoid the forming queue. In some embodiments, the system 601 assign an identifier to each vehicle 610 that enters and/or is in transit to the transfer station 600. By assigning an identifier to each vehicle 610 in the transfer station 600 and/or in transit to the 600, the system 601 may determine a traffic value, wherein the traffic value is indicative of a wait time associated with a dump queue. In some embodiments, the traffic value is transmitted by the server 602 to the vehicle 610. In addition, or alternatively, the server 602 may transmit to the vehicle 610 alternative transfer station locations with lower traffic values. The traffic value may be a wait time, a capacity, a queue length, etc.

Time is wasted by an operator of the vehicle 610 at the transfer station 600 while waiting in the queue because the operator of the vehicle 610 must constantly be monitoring the position and movement of the queue and constantly operate the vehicle 610 to continue its position in the queue.

In various embodiments of the present disclosure, the system 601 provides for methods and processes to avoid wasting time due to a queue at the transfer station 600. In addition, the system 601 increases the safety of the transfer station 600 by automating one or more movements of the vehicle 610.

In a first embodiment, the system 601 communicates to the vehicle 610 the forming of a queue at the transfer station 600. This communicated notification may be presented for display to the operator of the vehicle 610 on the electronic device or a display of the electronic device. The notification may also be presented audibly through one or more speakers. The electronic device may be a user device associated with the operator of the vehicle 610 or with a passenger of the vehicle 610. The electronic device may also be integrated into the vehicle 610. The notification may include the previously determined traffic value.

In one embodiment, the system 601 receives an indication of the traffic value in a first transfer station 600 and in a second transfer station. The system 601 may communicate the two traffic values to the vehicle 610 and present for display on the electronic device. In this manner, the operator of the vehicle 610 may determine to which transfer station 600 operator would like to use to dump the payload. In another embodiment, the system 601 determines the shortest queue of all possible transfer stations to which the vehicle 610 may use and communicates the shortest queue to the vehicle 610 through one or more methods described herein. In some embodiments, the system 601 automatically adjusts a trash route (e.g., route 308 of FIG. 5) of the vehicle 610 based at least on the various queue times determined by the system 601. For example, the system 601 may adjust the trash route of the vehicle 610 to direct the vehicle 610 along a shortest path from its current location to the transfer station with the shortest queue time while passing through each required pickup location (e.g., the future stops 314 of FIG. 5).

In determining the queue time (or traffic value) of the vehicle 610, the system 601 may take into account a weight of the vehicle 610 that is transmitted to the system 601. By way of example, the vehicle 610 may include an on-board payload scale with which the weight of the payload of the vehicle 610 is measured. This measured weight may be certified by the system 601 and used as the pre-dump weight of the vehicle 610. Upon receiving an indication of the measured weight of the vehicle 610 by the on-board scale, the system 601 may certify (e.g., authenticate) the weight through one or more means. Upon successfully verifying and/or certifying (e.g., authenticating) the weight, the system 601 may adjust the estimated queue time for the vehicle 610 because the vehicle 610 may need not queue for the scale 620 because the measured weight by the onboard scale may be used as the pre-dump weight for determining a billing charge to the vehicle 610. The vehicle 610 may transmit an indication to the system 601 that the operator intends to travel to the transfer station 600 to discharge the payload of the vehicle 610. This indication may be used to adjust the estimated queue time of additional vehicles to which this system 601 is communicatively coupled. In some embodiments, the system 601 receives indications of weight of refuse carried by a plurality of vehicles, a volume of refuse carried by a plurality of vehicles, and planned collection routes/transfer stations. The system 601 uses this received information to determine estimated current and future queue times (e.g., traffic values) at the various transfer stations associated with the plurality of vehicles. The system 601 may transmit to one or more vehicles (e.g., the vehicle 810) the estimated current queue time and/or an estimated future queue time associated with a planned or potential transfer station. In one embodiment, the system 601 determines an optimal routing of vehicles to the various transfer stations to minimize an average wait time of the vehicles or queue time of the transfer stations.

In some embodiments, the vehicle 610 may determine a payload weight of the vehicle 610 by comparing a preload weight of the vehicle 610 to a post-load weight capture. The preload weight may be the weight of the vehicle 610 prior to loading a payload (e.g., prior to collecting refuse along a refuse route). The post-load weight capture may be the weight of the vehicle 610 after loading the payload (e.g., after collecting refuse along the refuse route).

In addition to decreasing wasted time at the transfer station 600 through preemptively transmitting estimated queue times to the vehicle 610 and allowing for skipping the pre-dump weigh in with the scale 620, the system 601 may decrease wasted time at the transfer station 600 by automating movements within the queue. For example, the system 601 may provide mapping and planning of routes for the vehicle 610 while within the transfer station 600. These plannings and mappings may be used to automate one or more movements of the vehicle 610 while within the transfer station 600. For example, the system 601 may plan a route 612 for the vehicle 610. The route 612 may begin at the entrance to the transfer station 600 and proceed along a queue route through the scale 620 to the parking zone 632 in order for the vehicle 610 to discharge its payload at the transfer zone 630. In some embodiments the system 601 may automatically control one or more operating parameters (e.g., steering angle, travel speed, direction of travel, breaking amount, gear engagement, discharge actuation, etc.) to travel along the route 612. According to some embodiments, the automated movements of the vehicle 610 may include travelling in reverse along the queue over the scale 620 to the parking zone 632. In this manner, safety is increased due to the predictable nature of the automated movements of the vehicle 610. The vehicle 610 may include one or more sensors as described herein to sense the environment immediately surrounding the vehicle 610. This sensed environment may be transmitted to the system 601 to alter a planned route (e.g., the route 612) of the vehicle 610 to avoid obstacles (e.g., people, wearable sensors, vehicles, trash, animals, non-drivable surfaces, etc.). For example, the vehicle 610 may sense the presence of an obstacle 650 on the route 612. The vehicle 610 may transmit a communication to the system 601 indicating the presence of the obstacle 650. The system 601 may execute one or more adjustment protocols to plan an alternate route 608 to avoid the obstacle 650. The obstacle 650 may be any obstacle over which the vehicle 610 should not drive. For example, the obstacle 650 may be a person, a vehicle, an animal, trash, damage to the driving surface, etc. Likewise, the system 601 may stop the movement of the vehicle 610 due to the presence of an obstacle 640 around which the vehicle 610 cannot travel. For example, and as shown in FIG. 6, the obstacle 640 may be in the parking zone 632 and present a hindrance to a movement of the vehicle 610 from travelling along the route 612. Due to the enclosed space of the parking zone 632, the vehicle 610 may not be able to travel along an alternate path to avoid the obstacle 640. In such an embodiment, the system 601 may transmit an instruction to the vehicle 610 to stop movement along the route 612. In such an embodiment the system 601 may transmit a communication to the operator of the vehicle 610 to take control of the vehicle 610. According to an exemplary embodiment, the obstacle 640 may be a person associated with a wearable safety device. For example, a safety vest that transmits its location to the system 601. The safety vest transmits its location to the system 601 and the system 601 updates the map/planning to reflect the presence of the safety vest in the route 612. The presence of the safety vest (as indicated by the transmitted location) causes the system 601 to adjust the route 612 to the alternate route 612 or to transmit instructions to the vehicle 610 to adjust one or more operating parameters to avoid colliding with the safety vest.

In some embodiments the system 601 may automate one or more required movements of the vehicle 610. For example, the system 601 may plan the route 612 to pass through the scale 620. Upon arriving at the scale 620, the system 601 may transmit instructions to the vehicle 610 to stop movement in order to be weighed by the scale 620. Upon receiving an indication that the vehicle has successfully been weighed by the scale 620, the system 601 may transmit instructions to the vehicle 610 to continue along the route 612 to the transfer zone 630. Another example of a required movement may be to travel to the scale 620 and/or a billing location to execute a billing event after discharging the payload from the vehicle 610 into the transfer zone 630. In one embodiment, the billing event includes updating a billing ledger associated with the vehicle 610 with the determined billing amount based on the measured weight of the payload of the vehicle 610.

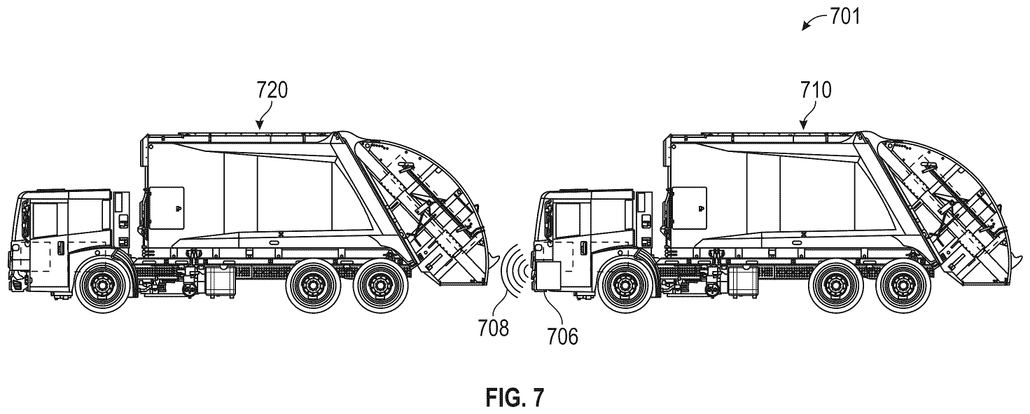

In an embodiment, the system 601 may coordinate movement between multiple vehicles to execute a queuing event, such as shown in FIG. 7.

Turning now to FIG. 7, a vehicle 710 is shown queuing behind a vehicle 720. In the queue shown in FIG. 7, the vehicle 710 is shown sensing the location of the vehicle 720 in relation to a position of the vehicle 710 through the use of one or more sensors 706. In one embodiment, the sensor 706 is one of a LiDAR sensor, a radar sensor, a time-of-flight sensor, an infrared sensor, a camera, etc. The sensor 706 may emit one or more sensor signals 708 that may interact with the vehicle 720 to indicate the presence of the vehicle 720. This indication of the presence of the vehicle 720 may be transmitted to a system 701 which may adjust one or more operating parameters of the vehicle 710. The system may be substantially the same as the system 601 as described in FIG. 6. The system 701 may have access to one or more predetermined thresholds which may be stored in a database and/or memory. The thresholds may be associated with a distance which the vehicle 710 must keep between itself and the vehicle 720. For example, the system 701 may receive the indication of the presence of the vehicle 720. This indication may be used to determine a distance between the vehicle 720 and the vehicle 710. The system 701 may compare this determined distance between the vehicle 720 and the vehicle 710 to the predetermined distance threshold. Responsive to the predetermined distance threshold exceeding the measured distance between the vehicle 720 and 710, the system 701 may adjust one or more operating parameters of the vehicle 710 to stop movement of the vehicle 710. Responsive to the determined distance between the vehicle 720 and the vehicle 710 exceeding the predetermined distance threshold, the system 701 may cause the adjustment of one or more operating parameters to advance the vehicle 710 towards the vehicle 720 until the measured distance between the vehicle 720 and 710 is less than the predetermined distance threshold. In this way, the vehicle 710 follows behind the vehicle 720 automatically as the vehicle 720 moves up in the queue. By automatically operating the vehicle 710, the operator of the vehicle 710 may engage in additional activities such as completing paperwork, planning a future trash route, communicating with coworkers, etc. accordingly, time is not wasted by the operator of the vehicle 710 while in the queue. Upon reaching a predefined position in the queue, the vehicle 710 may automatically end autonomous movements to follow the vehicle 720. For example, once the vehicle 720 reaches the parking zone, the vehicle 710 may become a “leader” of the queue. As the leader of the queue, the operator of the vehicle 710 must manually operate the vehicle 710 which may lead a vehicle behind the vehicle 710 in the queue.

The vehicle 720 acts as a mobile object which the vehicle 710 follows. Although FIG. 7 illustrates the mobile object that the vehicle 710 follows as a refuse vehicle, the mobile object may be any object that travels through a queue. By way of a non-limiting example, the mobile object may be a moving sign that travels along a track of a predefined path toward a transfer zone of a transfer station. In such a manner, the moving sign may be used to autonomously lead the vehicle 710 along the path. The mobile object may also be a non-refuse vehicle. The mobile object may be an autonomous buggy.

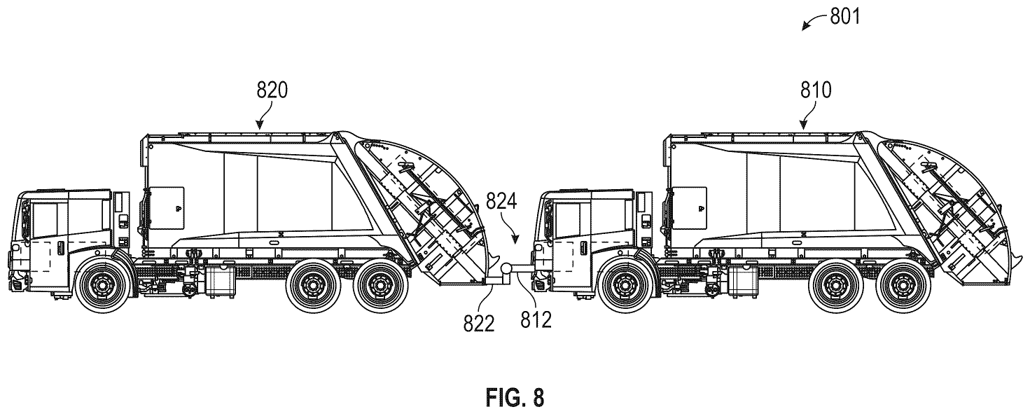

Various alternative methods of reducing wasted operator time while in a refuse transfer queue exists. For example, FIG. 8 illustrates a system 801 executing a leader-follower mode in which a first vehicle 810 is towed behind a second vehicle 820 in a queue. In one embodiment the vehicles 810, 820 may be equipped with a vehicle-coupling mechanism 824 (e.g., a hitch and tow bar mechanism) to couple the vehicle 810 and the vehicle 820. For example, the vehicle 820 may include a rear hitch 822 configured to couple to a front hitch of the vehicle 812. The vehicle-coupling mechanism 824 may include a ball and hitch, a frame hitch, a hitch and bar, etc. In coupling the vehicle 810 to the vehicle 820 with the vehicle-coupling mechanism 824, the vehicle 820 may tow the vehicle 810 along a queue so that the operator of the vehicle 810 need not constantly operate the vehicle while in the queue. In an alternative embodiment, the vehicle 810 pushes the vehicle 820 with the vehicle-coupling mechanism through the queue.

In some embodiments, the vehicle 820 and vehicle 810 may be communicatively coupled such that the operation of one vehicle may automatically adjust the operation of the other vehicle. The vehicle 810 may be communicatively coupled to the vehicle 820 wirelessly or by wire. For example the vehicle 810 may be communicatively coupled to the vehicle 820 through one or more networks, or the vehicle 810 may be communicatively coupled to the vehicle 820 through a wire (e.g., through the vehicle-coupling mechanism 824). By way of example, the vehicle 820 may transmit one or more instructions to operate the vehicle 810 in a manner corresponding to the operation of the vehicle 820 while in the queue and coupled by the vehicle-coupling mechanism 824. For example, responsive to the vehicle 820 accelerating (or receiving an instruction to accelerate), the vehicle 820 may transmit to the vehicle 810 instructions to accelerate. Likewise, when the vehicle 820 decelerates or adjusts a steering position (or receives an instruction to decelerate or adjust a steering position), the vehicle 820 may transmit instructions to the vehicle 810 to decelerate or adjust a steering angle so that the vehicle 810 operates in tandem with vehicle 820. In some embodiments, this leader-follower system need not require the vehicle-coupling mechanism 824. Rather, the vehicles 810, 820 communicate with each other through one or more servers or communication protocols directly to operate in sync with each other while in the queue.

In some embodiments the vehicle 820 need not be a refuse vehicle as illustrated in FIG. 8. for example, the vehicle 820 may be a specialized tug vehicle to tow one or more refuse vehicles along the queue.

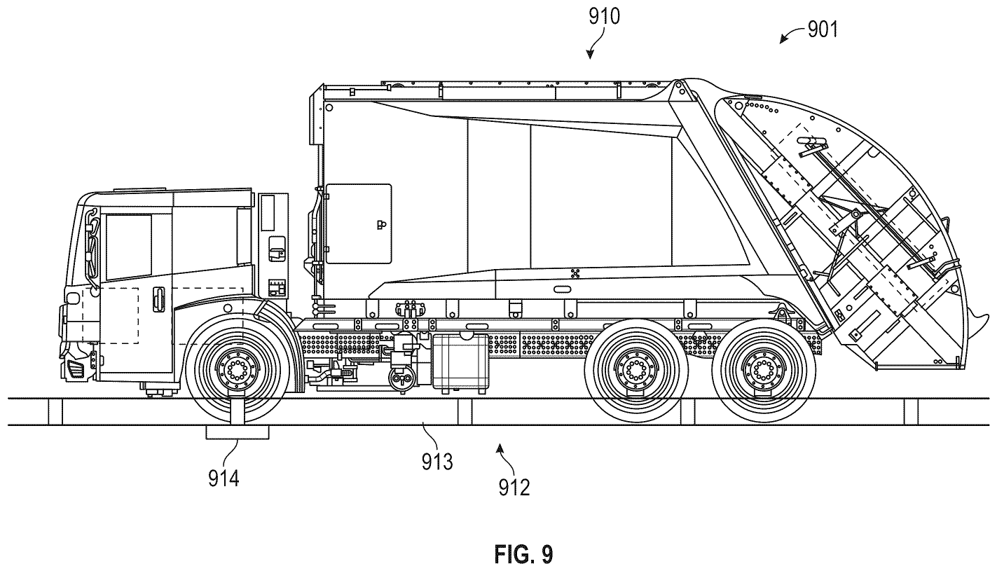

Yet another embodiment for an automated queueing, as shown in FIGS. 9-10, is a system 901 for coordinating movements of vehicles in a transfer station queue. The system 901 may include, or be communicatively coupled to, a track 912 (e.g., a vehicle transport device) following a predefined path that leads from a queue start to a transfer zone. The track 912 may be an automated-vehicle-movement track which may include a vehicle-directing mechanism 913 (e.g., a conveyor) and one or more vehicle-coupling mechanisms 914. The vehicle-coupling mechanism 914 may be coupled to the vehicle-directing mechanism 913 and be configured to removably couple to a vehicle 910. In one embodiment, the vehicle-coupling mechanism 914 may couple to one or more tractive elements of the vehicle 910 and/or a hitch of the vehicle. Once engaged with the vehicle 910, the vehicle-coupling mechanism 914 may be advanced along the vehicle-directing mechanism 913 to advance the vehicle 910 along the predefined path without any operator input to the vehicle 910. The track 912 may be communicatively coupled to the system 901 and receive one or more instructions from the system 901 in order to advance the vehicle 910 along the queue (e.g., the queue 1014 of FIG. 10). As shown in FIG. 10, the queue 1014 may comprise of multiple vehicles 1010, 1016.

In various implementations, the embodiments described and illustrated in FIGS. 7-9 may exist along a predefined path from an entrance of a transfer station (or other starting point) and lead to a transfer zone within the transfer station. The transfer zone may relate to a dump area at which the vehicle 710 may unload a payload of refuse or other collected materials. The predefined path may traverse a measuring device (e.g., a scale), a billing counter, an inspection zone, etc.

In some implementations, the embodiments described in FIGS. 7-9 lead a vehicle (e.g., the vehicle 710) along a predefined path to the transfer zone. The vehicle may be configured to stop (e.g., maintain the vehicle at) at a positional location outside of the transfer zone (e.g., at the front of the queue, entrance to the transfer zone, etc.) while all available spots within the transfer zone are occupied. Upon receiving an indication of a vacancy in one of the spots within the transfer zone, the vehicle may autonomously (or manually) proceed into the transfer zone. In some embodiments, the vehicle is directed in a reverse direction to approach the dump zone to unload the collected payload at the dump site within the dump zone.

The vehicle (e.g., the one or more processors of the vehicle) may receive an indication of the vacancy by one or more methods. For example, a vacancy light may be illuminated above the vacant position, which the one or more processors may sense through vision sensors and image processing. In other embodiments, the one or more processors may use computer vision and image processing to sense the environment within the transfer zone to determine when a vacancy is available.

In some implementations, the embodiments described in FIGS. 7-9 are only executed in response to the vehicle entering a geofenced location, for example, a geofenced location associated with the transfer station (e.g., surrounding the transfer station) or an area within the transfer station.

FIG. 10 illustrates a transfer station 1000. The transfer station 1000 may be substantially similar to the transfer station 600 of FIG. 6. The transfer station 1000 may include a transfer zone 1030, a parking zone 1032, a vehicle measuring device 1020 (e.g., a scale), and a track 1012. The track 1012 may be substantially similar to the track 912 of FIG. 9. The track 1012 may accommodate multiple vehicles 1010, 1016, 1021 and advance the multiple vehicles 1010, 1016, 1021 along the queue 1014. In an embodiment, the queue 1014 passes over the vehicle measuring device 1020. In such embodiments, the track 1012 may advance vehicles 1010, 1016, 1021 such that only one vehicle is placed on the vehicle measuring device 1020 at a time so as to provide means for the vehicle measuring device 1020 to measure the pre-dump weight of each vehicle 1010, 1016, 1021 prior to discharging each payload into the transfer zone 1030. Likewise the track 1012 may be configured so as to advance the vehicles to the transfer zone 1030. In some embodiments, the vehicle 1021 is stopped at a threshold 1040 while waiting for an active vehicle 1018 to discharge its payload into the transfer zone 1030. Once the active vehicle 1018 has completed discharging its payload into the transfer zone 1030, the active vehicle 1018 exits the parking zone 1032 and exits the transfer station 1000 (and/or proceeds to the vehicle measuring device 1020 to execute a post dump weighing). Once the active vehicle 1018 exits the parking zone 1032, the track 1012 may advance the vehicle 1021 to the transfer zone 1030 in some embodiments the track 1012 may be split into multiple components so as to advance one vehicle at a different rate of speed as another vehicle. For example, the track 1012 may be configured to advance the vehicle 1021 to the parking zone at a different rate of speed than the vehicles 1010, 1016.

In one embodiment, the vehicles 1010, 1016, 1018, 1021, enter the track 1012 in reverse such that they are moved along the queue in reverse so that the track 1012 positions each vehicle in an appropriate dumping orientation at the transfer zone 1030 to avoid operator error while reversing into the parking zone 1032. In some embodiments, the track 1012 may include a mechanism or path to allow the vehicles to enter the track in a forward orientation and then end in the parking zone in a different orientation. For example, the track 1012 may include a turntable mechanism. In another embodiment, the track 1012 may include a 2-point turn in the track 1012.

Turning now to FIG. 11, a process 1100 for automating movements of vehicles in a queue is illustrated. FIG. 11 may include one or more steps, including steps 1110, 1120, 1130, and 1140, which may be executed by one or more processors of a server and/or controller. Step 1110 includes identifying a start position, a scale position, and a dump position. This identification can be made through receiving a user's input into an electronic device input system. Step 1120 includes generating a path between the start position, through the scale position, to the dump position. Through one more machine learning model and/or frameworks including one or more functions and/or layers, the system may map the path between the start position, through the scale position, to the dump position. In other embodiments, the system receives an input indicating the path from an electronic device associated with the user.

Step 1130 includes receiving an indication of a first vehicle arriving at the start position. The system may then receive the indication of the first vehicle arriving at the start position by processing one or more images, receiving a geotagging location of the first vehicle, or receive a transmission from the first vehicle.

Step 1140 includes, responsive to the indication of the first vehicle arriving at the start position, transmitting a first instruction to automatically control a movement of the first vehicle along the path to the dump position; and wherein, the first vehicle arrives at the dump position in a dumping orientation. The first instruction can be transmitted to the first vehicle to automatically adjust one or more operating parameters of the first vehicle. Additionally, or alternatively, the system may transmit the first instruction to a track mechanism, as described in FIGS. 9-10. In other embodiments, the first instruction may be transmitted to a vehicle ahead of the first vehicle in the queue.

In the present disclosure, the terms system and server may be used interchangeably. The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media (e.g., non-transitory computer-readable medium) for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A system comprising:
a vehicle measuring device;
a transfer zone; and
a vehicle transport device, the vehicle transport device comprising:
a vehicle-coupling mechanism to couple to at least one vehicle;
a vehicle-directing mechanism to direct the at least one vehicle coupled to the vehicle-coupling mechanism along a predefined path including the vehicle measuring device and the transfer zone;
one or more processors; and
a non-transitory computer-readable medium containing instructions that when executed by the one or more processors cause the one or more processors to:
receive an indication of the at least one vehicle being coupled to the vehicle-coupling mechanism; and
responsive to receiving the indication of the at least one vehicle being coupled to the vehicle-coupling mechanism, adjusting one or more operating parameters of the vehicle-directing mechanism to direct the at least one vehicle along the predefined path.

2. The system of claim 1, wherein the predefined path leads the at least one vehicle between at least two of the vehicle measuring device, the transfer zone, and a queue.

3. The system of claim 1, wherein the vehicle-directing mechanism is a conveyor on which at least a portion of the at least one vehicle is supported.

4. The system of claim 1, wherein the vehicle-directing mechanism is a tug vehicle configured to couple to a hitch or a tractive element of the at least one vehicle.

5. The system of claim 1, wherein the vehicle-directing mechanism is a refuse vehicle and the vehicle-coupling mechanism is a hitch and tow bar.

6. A refuse vehicle comprising:
a chassis;
one or more tractive elements;
a prime mover;
one or more processors; and
a non-transitory computer-readable medium containing instructions that when executed by the one or more processors cause the one or more processors to:
receive an indication of a presence of a mobile object;
determine a distance between the refuse vehicle and the mobile object;
responsive to the distance between the refuse vehicle and the mobile object exceeding a first threshold, adjusting at least one operating parameter of the refuse vehicle to advance the refuse vehicle toward the mobile object; and
responsive to the distance between the refuse vehicle and the mobile object not exceeding the first threshold, adjusting the at least one operating parameter of the refuse vehicle to stop the refuse vehicle from advancing towards the mobile object.

7. The refuse vehicle of claim 6, wherein the instructions further cause the one or more processors to adjust the at least one operating parameter along a predefined path toward a transfer zone.

8. The refuse vehicle of claim 7, wherein the instructions further cause the one or more processors to:
maintain the refuse vehicle in a positional location outside a parking zone in response to arriving at the parking zone; and
in response to receiving an indication of a vacancy within the parking zone, adjusting the at least one operating parameter of the refuse vehicle to enter the parking zone.

9. The refuse vehicle of claim 8, wherein the instructions further cause the one or more processors to:
cause the refuse vehicle to enter the parking zone; and
adjust the at least one operating parameter such that the refuse vehicle approaches the transfer zone in a reverse direction.

10. The refuse vehicle of claim 6, wherein the mobile object is a second refuse vehicle.

11. The refuse vehicle of claim 6, wherein the instructions further cause the one or more processors to adjust the at least one operating parameter in response to the refuse vehicle being within a geofenced location associated with a refuse transfer station.

12. The refuse vehicle of claim 6, wherein the instructions further cause the one or more processors to receive a communication associated with a position of the mobile object.

13. The refuse vehicle of claim 12, wherein the one or more processors are configured to receive the communication from the mobile object.

14. A system for reducing wait times at a refuse transfer station comprising:
a measuring device;
one or more processors communicably coupled to the measuring device; and
a non-transitory computer-readable medium containing instructions that when executed by the one or more processors cause the one or more processors to:
receive, from the measuring device, a measured weight of a payload of a refuse vehicle,
determine, based on the measured weight, a wait time for the refuse vehicle to discharge the payload at the refuse transfer station, and
transmit the wait time to the refuse vehicle.

15. The system of claim 14, wherein the instructions further cause the one or more processors to determine, based on the measured weight, a billing charge for the payload.

16. The system of claim 15, wherein the instructions further cause the one or more processors to authenticate the measured weight as a certified measured weight.

17. The system of claim 16, wherein the instructions further cause the one or more processors to:
receive an indication of an arrival of the refuse vehicle at the refuse transfer station;
responsive to authenticating the measured weight as the certified measured weight and receiving the indication of the arrival of the refuse vehicle at the refuse transfer station:
update a billing ledger associated with the refuse vehicle with the billing charge; and
transmit for display a communication indicating that the refuse vehicle may discharge the payload.

18. The system of claim 14, wherein the one or more processors receive the measured weight of the payload of the refuse vehicle by comparing a preload weight captured by the measuring device to a post-load weight captured by the measuring device.

19. The system of claim 14, wherein the measuring device is positioned onboard the refuse vehicle.

20. The system of claim 14, wherein the measuring device is a scale external to the refuse vehicle.
